(19) United States
(12) Patent Application Publication
(10) Pub. No.: US 2026/0154642 A1
(43) Pub. Date: Jun. 4, 2026

(54) MITIGATING RISK OF A DIGITAL WORKER EXECUTING A TASK USING LARGE LANGUAGE MODELS

(71) Applicant: International Business Machines Corporation, Armonk, NY (US)

(72) Inventors: Swaminathan BALASUBRAMANIAN, Troy, MI (US); Pierre C. BERLANDIER, San Diego, CA (US); Santosh RAJASHEKAR, Bangalore (IN); Selvi JOHN, Bangalore (IN); Jason MALINOWSKI, Pittstown, NJ (US)

(21) Appl. No.: 18/966,121

(22) Filed: Dec. 2, 2024

(51) Int. Cl. G06Q 10/0635

(52) U.S. Cl. CPC G06Q 10/0635

(57) ABSTRACT

A risk monitor component may intercept a request for execution of a function on one or more computer systems. The request may be generated by a digital worker. The risk monitor component may determine, utilizing a large language model (LLM), a potential impact of the execution of the function and apply a fuzzy logic-based scoring algorithm, to the potential impact, to compute a risk score based on defuzzification of previous qualitative measures of risk correlations. The risk monitor component may determine, based on the risk score, an execution path for the execution of the function. The execution path may include performing a full execution of the function, performing a partial execution of the function, or preventing the execution of the function

### BACKGROUND

The present invention relates to digital workers, and for example to the field of assessing risk of a digital work executing a function.

A “digital worker” may refer to a software robot, which is trained to perform specific functions or processes in partnership with human workers. The digital worker can assist the human workers in complex processes. The digital worker can improve workforce productivity,

### SUMMARY

In some implementations, a method includes intercepting a request for execution of a function on one or more computer systems, wherein the request is generated by a digital worker; and determining, utilizing a large language model (LLM), a potential impact of the execution of the function; applying a fuzzy logic-based scoring algorithm, to the potential impact, to compute a risk score based on defuzzification of previous qualitative measures of risk correlations; and determining, based on the risk score, an execution path for the execution of the function, wherein the execution path includes performing a full execution of the function, performing a partial execution of the function, or preventing the execution of the function.

In some implementations, a computer system comprising: a processor set; one or more computer-readable storage media; and program instructions stored on the one or more computer-readable storage media to cause the processor set to perform operations comprising: intercepting a request for execution of a function on one or more computer systems; determining, utilizing a large language model (LLM), a potential impact of the execution; determining, utilizing the LLM, a correlation between a current context associated with the function and a historical context associated with the function; applying a fuzzy logic-based scoring algorithm, to the potential impact and the correlation, to compute a risk score associated with the execution of the function; and based on the risk score, selectively: performing a full execution of the function, performing a partial execution of the function, or preventing the execution of the function.

In some implementations, a computer program product comprising: one or more computer-readable storage media; and program instructions stored on the one or more computer readable storage media to perform comprising: determining, utilizing a machine learning model, a potential impact of execution a function on one or more computer systems; determining, utilizing the machine learning model, a correlation between a current context associated with the function and a historical context associated with the function; applying a fuzzy logic-based scoring algorithm, to the potential impact and the correlation, to compute a risk score associated with the execution of the function; and based on the risk score, selectively: performing a full execution of the function, performing a partial execution of the function, or preventing the execution of the function.

### BRIEF DESCRIPTION OF THE DRAWINGS

FIG. 1 is a diagram of an example implementation described herein.

FIG. 2 is a flowchart of an example process for mitigating risk associated with a digital worker executing a function.

FIGS. 3A-3E are diagrams of an example implementation described herein.

FIG. 4 is a diagram of an example computing environment in which systems and/or methods described herein may be implemented.

FIG. 5 is a diagram of example components of one or more devices of FIG. 1.

FIG. 6 is a flowchart of an example process performed by a host system.

### DETAILED DESCRIPTION

The following detailed description of example implementations refers to the accompanying drawings. The same reference numbers in different drawings may identify the same or similar elements.

A digital worker may refer to a software application (e.g., a software-based worker) that can independently execute meaningful parts of complex, end-to-end processes using a range of skills. A digital worker may leverage artificial intelligence capabilities, like machine learning, computer vision, and natural language processing, to execute a sequence of functions within a given workflow.

A digital worker may perform specific functions or processes to assist human workers in complex processes. When performing the functions, the digital worker may connect to computer systems. For example, the digital worker may have pre-built/custom function that connect to backend/external computer systems.

A digital worker may operate on a device of a user. When the device is compromised, the digital worker may be comprised. In this regard, a function performed by the compromised digital worker may cause significant damage to the computer systems. For example, the computer systems may perform unintended operations. For instance, the compromised digital work may perform a function such an unauthorized access to protected data.

Existing methods detect user anomalies. However, existing methods do not timely prevent a compromised digital worker from performing an unauthorized function. In this regard, there is a need to ensure that functions, performed by digital workers, are authorized and secured based on such detecting anomalies.

Implementations described herein are directed to computing a risk score associated with execution of a function initiated by a digital worker and performing an action based on the risk. The risk score may indicate a risk associated with the execution of the function. The action may include preventing the execution of the function when the risk score is within a first range (or is a first score); performing the partial execution of the function when the risk score is within a second range (or is a second score), and performing a full execution of the function when the risk score is within a third range (or is a third score). The first range is before the second range. In other words, the second range exceeds the first range. The second range is before the third range. In other words, the third range exceeds the second range. The first score exceeds the second score. The second score exceeds the third score.

In some implementations, a risk monitor component may compute the risk score and cause the action to be performed. For example, the risk monitor component may detect a request to execute a function. Prior to execution, the risk monitor component may intercept and analyze the request. The risk monitor component may analyze the request using a machine learning model. For example, the risk monitor component may analyze the request using a generative artificial model, such as a large language model. Based on analyzing the request, the risk monitor component may determine a potential impact of the execution by utilizing a large language model, determine an estimated correlation between an expected/estimated context and an actual context, and determine an estimated security posture.

The context (expected/estimated or actual) may be determined using context data. The context data may identify a location associated with the function (e.g., associated with a user performing the function or causing the function to be performed), a schedule associated with the function (e.g., associated with the user), a device associated with the function (e.g., associated with the user), a biometrics of the user, among other examples. In some examples, the context data may include biometric data associated with the function. A “security posture,” as used herein, may refer to a measure of security of a location associated with the function (e.g., whether the location is secure or unsecure), a measure of normalcy of an action associated with the function (e.g., whether the action is normal or abnormal), a measure of security of a device initiating the function (e.g., whether the device is a personal device or a work device which tends to be more secure than the work device), a measure of security of a network associated with the device (e.g., whether the network is a public network or a private network which tends to be more secure than the public network).

After determining the potential impact, the estimated correlation, and the estimated security posture, the risk monitor component may use a fuzzy logic based scoring method to compute a risk score associated with the execution of the function. In some implementations, rules of the fuzzy logic based scoring method may be based on a measure of risk associated with the estimated correlation, a measure of risk associated with the estimated correlation, and/or a measure of risk associated with the security posture.

Based on the computed risk score, the risk may determine an action to perform with respect to the function. For example, the risk monitor preventing the execution of the function when the risk score is within a first range (or is a first score); performing the partial execution of the function when the risk score is within a second range (or is a second score), and performing a full execution of the function when the risk score is within a third range (or is a third score). The first score exceeds the second score. The second score exceeds the third score.

Implementations described herein are directed to securing digital workers, thereby remedying the deficiencies of existing methods with respect to securing digital workers. As used herein, “securing a digital worker” may refer to preventing the digital worker from performing a function that poses a risk to a computer system on which the function is performed. Implementations described herein utilize machine learning models in combination with a fuzzy logic based scoring algorithm to compute a risk score. The machine learning models may provide a qualitative assessment of execution of the function. The machine learning models may include generative AI models, such as LLMs. Implementations described herein may provide fine grained response to risks associated with digital workers executing functions.

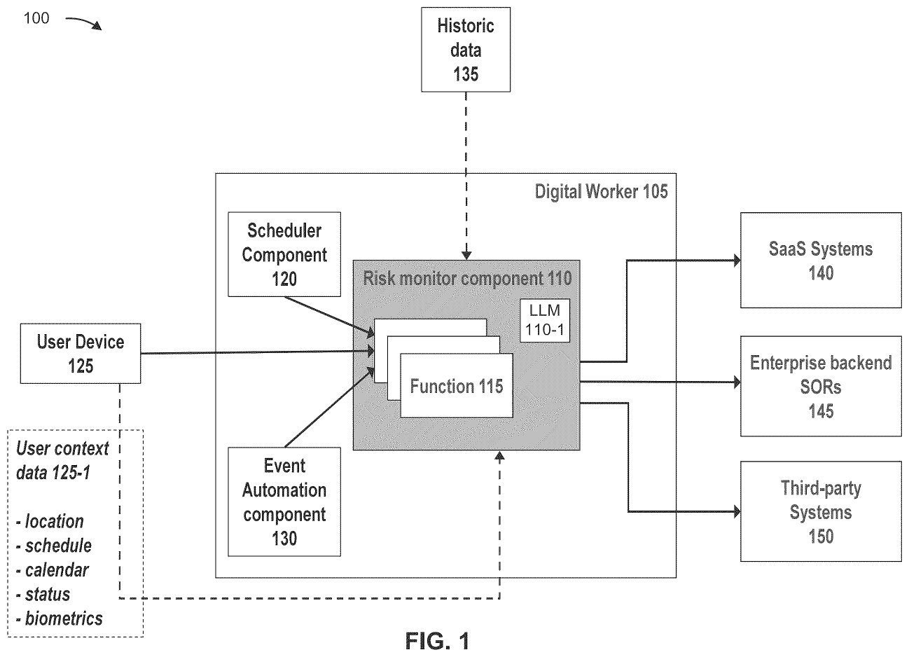

FIG. 1 is a diagram of an example implementation 100 described herein. As shown in FIG. 1, implementation 100 may include a digital worker 105 and a risk monitor component 110. In some examples, digital worker 105 may be implemented on a device. The device may include a communication device and a computing device. For example, the device may include a server, a wireless communication device, a mobile phone, a user equipment, a laptop computer, a tablet computer, a desktop computer, a wearable communication device, or a similar type of device.

Risk monitor component 110 may include one or more devices that monitor one or more functions 115 (individually “a function 115”) that are to be performed by digital worker 105. For example, risk monitor component 110 may intercept requests to execute the one or more functions 115. The requests may be generated by components and devices associated with digital worker 105 and may be intended for one or more computer systems. Risk monitor component 110 may intercept the requests to execute the one or more functions 115 and analyze information regarding the one or more functions 115. Based on analyzing the one or more functions, risk monitor component 110 may determine a risk associated with the one or more functions 115 being executed.

In some implementations, risk monitor component 110 may be part of a security layer associated with the device that implements the digital worker 105. As shown in FIG. 1, risk monitor component 110 may include a machine learning model. In some examples, the machine learning model may be an LLM. For example, risk monitor component 110 may include an LLM 110-1. Risk monitor component 110 may use LLM 110-1 to analyze the information a function 115. Because the potential for anomalous situations is diverse, LLM 110-1 may be trained with a wide body of knowledge. In some examples, specific policies (e.g., of an entity) about anomalies may be compiled into documents and added to a vector database so that the retrieval-augmented generation (RAG) pattern may be applied to these documents, thereby providing specific anomaly detection opportunities that are more tailored to the entity. In some examples, a generic LLM may be fine-tuned through a specific set of anomalous situations, including specific context data elements to help on response accuracy, and also include some knowledge relative to the functions that are executed by a digital worker, and their potential degree of risk if the digital worker is compromised.

In some examples, risk monitor component 110 may include a first LLM 110-1 trained to determine a possible impact of executing the function 115 and a second LLM 110-1 trained to determine a correlation between a current context associated with the function 115 and a historical context associated with the function 115. In some examples, second LLM 110-1 may fit more the traditional machine learning model than first LLM 110-2, as it would be supervised learning, fed by historical data. LLM 110-1 may be trained using training data that include historical data that identifies historical impacts on computer systems for executing different functions, historical parameters of the different functions, historical contexts associated with the different functions, among other examples.

As shown in FIG. 1, implementation 100 may include a scheduler component 120, a user device 125, and an event automation component 130. Scheduler component 120, user device 125, and event automation component 130 may provide the requests to digital worker 105. For example, scheduler component 120 may include one or more devices that provide a request to execute a function periodically (e.g., every thirty minutes, every hour, every day, among other examples).

User device 125 may provide a request to execute a function based on an input from a user of user device 125. User device 125 includes one or more devices capable of receiving, generating, storing, processing, and/or providing information associated with mitigating risk associated with functions to be performed by digital worker 105, as described elsewhere herein. User device 125 may include a communication device and a computing device. For example, user device 125 may include a wireless communication device, a mobile phone, a user equipment, a laptop computer, a tablet computer, a desktop computer, a wearable communication device, or a similar type of device.

In some examples, user device 125 may generate user context data 125-1 associated with a function 115. For example, user device 125 may generate user context data 125-1 as part of providing the request for execution of the function 115. In some examples, risk monitor component 110 may obtain user context data 125-1 and may use user context data 125-1 to compute a risk score associated with the function 115. For example, risk monitor component 110 may obtain user context data 125-1 and historic data 135 to determine a correlation between a current context associated with the function 115 and a historical context associated with the function 115.

As shown in FIG. 1, user context data 125-1 may identify a location of user device 125, a schedule (e.g., a date and a time) of user device 125 providing the request, a calendar associated with user device 125, a status of user device 125, biometrics of the user when the request is provided, among other examples. The status of user device 125 may indicate whether user device 125 has been declared lost or stolen. For example, if there is no location information, but a MAC address of user device 125 identifies user device 125 (a location of user device 125) and check its status). In some examples, user device 125 may include one or more sensor devices to capture the location and the biometrics.

Event automation component 130 may include one or more devices that provide a request to execute a function based on a event. The event may include a day, a time of day, an instruction, among other examples.

As explained herein, functions 115 may be executed on one or more computer systems. As shown in FIG. 1, the one or more computer systems may include software as a service (SaaS) systems 140, enterprise backend system of records (SORs) 145, and third-party systems 150. The one or more computer systems may store data, application data, software applications, among others examples.

As shown in FIG. 1, implementation 100 may include historic data 135. Historic data 135 may identify historical locations of user device 125, historical schedules (e.g., dates and times) of user device 125 providing the request, historical calendar associated with user device 125, historical statuses of user device 125, historical biometrics of the user when the request is provided, among other examples. In some examples, historic data 135 may identify a frequency of a function 115 being executed, an average parameter for the function 115, among other examples.

As indicated above, FIG. 1 is provided as an example. Other examples may differ from what is described with regard to FIG. 1. As an example, while FIG. 1 appears to illustrate a single digital worker, in practices implementations described herein are directed to multiple digital workers. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

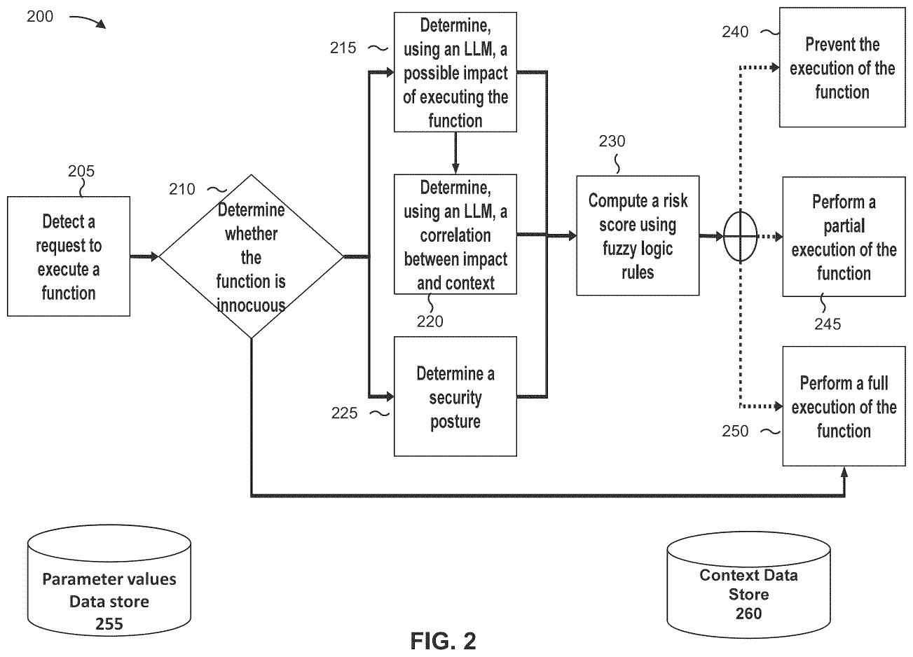

FIG. 2 is a flowchart of an example process 200 for mitigating risk associated with a digital worker executing a function. In some implementations, the steps of process 200 may be performed by risk monitor component 110. In some implementations, the steps of process 200 may be performed using information from data stored in a parameter values data store 255 and context data store 260.

In some implementations, parameter values data store 255 may include a data store that stores historical parameters values included in historical requests for different functions 115 to be performed. For example, if the function is to provision virtual machines, the parameter may be the number of virtual machines and the parameter value may be the value of the number virtual machines.

In some implementations, parameter values data store 255 may store information regarding different functions 115. For example, parameter values data store 255 may store documentation actions/functions performed by the different functions 115. The documentation may include a natural language description of the actions/functions performed by the different functions 115. For instance, a first description may indicate that a first function provisions the given number of VMs on a cloud provider of a company. A second description may indicate that a second function sends an email to an email address of a client with a particular text. A third description may indicate that a third function share a social media post/social media message via an official marketing account, of the company, using particular text. In some implementations, context data store 260 may include a data store that stores historic data 135 (as an example).

As further shown in FIG. 2, process 200 may include detecting a request to perform a function (block 205). For example, risk monitor component 110 may detect the request. The request may be initiated or triggered by scheduler component 120, user device 125, or event automation component 130. In some implementations, the request may identify the functions and one or more parameters regarding the function.

As further shown in FIG. 2, process 200 may include determining whether the function is innocuous (block 210). For example, risk monitor component 110 may determine whether the request is innocuous. For instance, risk monitor component 110 may determine whether the execution of the function will have a negative impact on the one or more computer systems (e.g., described above), whether the execution of the function will cause a data breach risk, whether the execution of the function will cause a data corruption risk, whether the execution of the function will cause a degradation of the performance of the one or more computer systems, among other examples.

As further shown in FIG. 2, process 200 may include determining, using an LLM, a possible impact of executing the function (block 215). For example, risk monitor component 110 may determine the possible impact if the request is not innocuous. In some implementations, the possible impact may be qualitative. For example, the possible impact may be identified as high, medium, and low. In some implementations, LLM 110-1 may determine quantitative information regarding the execution of the function. For example, LLM 110-1 may determine a score regarding the execution of the function.

In some implementations, when a function 115 is about to be executed, risk monitor component 110 creates an LLM prompt based on the description of the function 114 and the parameters values (identified in the request) used by the function 115. The prompt may inquire about possible impacts of executing the function 115 as well as a qualitative assessment for each impact. Risk monitor component 110 may generate a prompt and provide the prompt to LLM 110-1. In some examples, risk monitor component 110 may generate the prompt using information included in the request, information regarding the skill (e.g., obtained from parameter values data store 255), historical information regarding the function (e.g., obtained from parameter values data store 255).

In some implementations, LLM 110-1 may determine the potential impact based on the parameter value of the request and/or the function to be executed. One example of a prompt may indicate that LLM 110-1 is to qualify the potential impacts of provisioning a number of VMs (e.g., 1350 VMs) on the cloud provider of the company. The possible impact may be determined based on the parameter value (e.g., the number of VMs). Another example of a prompt may indicate that LLM 110-1 is to qualify the potential impacts of sending an email (e.g., with particular text) to a particular client. The possible impact may be determined based on the parameter value (e.g., the particular text). Yet another example of a prompt may indicate that LLM 110-1 is to qualify the potential impacts of sending a particular message through the official corporate marketing channel. The possible impact may be determined based on the parameter value (e.g., the message or the content of the message).

As further shown in FIG. 2, process 200 may include determining, using an LLM, a correlation between the impact and the context (block 220). For example, risk monitor component 110 may determine the correlation using LLM 110-1. For example, risk monitor component 110 may generate an LLM prompt to determine a measure of a correlation between a current context (assumed and known data points) correlates with the function to be executed (e.g., an action to be performed as a result of the function being executed).

For example, the prompt may indicate “are <these observed facts> aligned with someone performing <this action>.” For example, the correlation may be identified as high, medium, and low. In some implementations, LLM 110-1 may determine quantitative information regarding the function. In some implementations, risk monitor component 110 may determine a current location (e.g., of user device 125), a current schedule for providing the request, a current calendar associated with providing the request, a status of user device 125, biometrics of the user when the request is provided, among other examples.

In some implementations, with respect to the correlation, risk monitor component 110 may compare a current location of user device 125 (which transmitted the request) and a historical location of user device 125. For example, risk monitor component 110 may determine that a location correlation is high if the current location and the historical location is within a first distance threshold, that a location correlation is medium if the current location and the historical location is not within the first distance threshold but within a second distance threshold that exceeds the first distance threshold, that a location correlation is low if the current location and the historical location is not within the second distance threshold but within a third distance threshold that exceeds the second distance threshold.

Risk monitor component 110 may determine that a schedule correlation is high if the current schedule and a historical current schedule is within a first difference threshold, that the schedule correlation is medium if the current schedule and the historical schedule is not within the first difference threshold but within a second difference threshold that exceeds the first difference threshold, that a schedule correlation is low if the current schedule and the historical schedule is not within the second difference threshold but within a third difference threshold that exceeds the second difference threshold. Risk monitor component 110 may determine a calendar correlation and a status correlation in a similar manner.

In some implementations, risk monitor component 110 may determine a location risk based on a type of the current location. For example, risk monitor component 110 may determine that the location risk is high if the current location is a public location (e.g., an airport, a transportation station, a shopping center, among other examples). Risk monitor component 110 may determine that the location risk is medium if the current location is a residence as opposed to the historical location (e.g., a place of employment of the user).

In some implementations, risk monitor component 110 may compare current biometrics and historical biometrics. For example, risk monitor component 110 may compare a current heartbeat of a user of user device 125 (at a time when the request was provided using user device) and a historical heartbeat associated with sending the request. If the current heartbeat exceeds the historical heartbeat, risk monitor component 110 may detect a risk associated with executing the function. For example, risk monitor component 110 may determine that the user is under duress to perform the function. As another example, risk monitor component 110 may determine that user device 125 is provided at an unsecure location (e.g., a train station is in a foreign country) and attempting to perform a significant software or firmware update using a cellular device instead of a work computer.

In some situations, risk monitor component 110 may select different portions of LLM 110-1 to determine the potential impact and the correlation. In some examples, the different portions may be selected based on the content of the prompt. Implementations herein may create an instance of a LLM prompt using a prompt template and placeholders for the situation at hand. In some situations, risk monitor component 110 may use different data sources to generate the prompt. Assume the prompt template is “Are <these observed facts> aligned with someone performing <this action>?” The “observed facts” that are stated in the prompt are the ones that can be coming from the different data sources. For example, observed facts coming from different data sources can be: location is a dive bar, 130 miles from the office; user has elevated heart rate; and on thanksgiving day. In this regard, the corresponding prompts would be: is someone with an elevated heart rate consistent with pressing the “launch” button?; is someone pressing the “launch” button on Thanksgiving day an anomaly?; is pressing the “launch” button in a dive bar a common occurrence?

As further shown in FIG. 2, process 200 may include determining a security posture (block 225). For example, risk monitor component 110 may determine the security posture. In some implementations, the qualitative information (described above regarding the possible impact and the correlation) may form the security posture.

As further shown in FIG. 2, process 200 may include computing a risk score using fuzzy logic rules (block 230). For example, risk monitor component 110 may determine the risk score

using fuzzy logic rules. For instance, risk monitor component 110 may apply the fuzzy logic rules to determine a level of action to be performed with respect to the function (e.g., block execution of the function, allow partial execution of the function, or allow full execution of the function). In some implementations, the fuzzy logic rules may be based on the possible impact and the correlation. The fuzzy logic rules may include logic statements designed explicitly by humans based on their domain expertise. For example, cybersecurity analysts would assess a risk level based on a combination of facts. For instance, the outcome from the LLM to the prompt “Is pressing the “launch” button in a dive bar a common occurrence?” may result in a low value for the location correlation. After all the factors have been evaluated, the fuzzy logic rules that combine the different factors may be applied and may provide a combined, final risk result.

As further shown in FIG. 2, process 200 may include preventing the execution of the function (block 240). For example, risk monitor component 110 may prevent the execution of the function if the risk score is a score that satisfies a first threshold.

As further shown in FIG. 2, process 200 may include performing a partial execution of the function (block 245). For example, risk monitor component 110 may perform a partial execution of the function if the risk score is a score that satisfies a second threshold that is less than the first threshold. A partial execution of a function may refer to an execution mode where the function may be allowed to perform a subset of the full capabilities of the function. The partial execution may be used in scenarios where the risk score suggests that a full execution could be risky, but a limited action might be acceptable. For example, if a function typically provisions many VMs, a partial execution might limit the number of VMs provisioned or place additional monitoring on the execution of the function.

In some implementations, a user may evaluate the partially executed function to determine whether a remaining portion of the function is to be executed.

As further shown in FIG. 2, process 200 may include performing a full execution of the function (block 250). For example, risk monitor component 110 may perform a full execution of the function if the risk score is a score that satisfies a third threshold that is less than the second threshold.

In some situations, risk monitor component 110 may perform the full execution of the function if risk monitor component 110 determines that the function is innocuous. For example, risk monitor component 110 may determine that the function is innocuous if the function involves posting a message on an internal website (e.g., with respect to an entity or an organization associated with scheduler component 120, user device 125, and/or event automation component 130. Additionally, or alternatively, risk monitor component 110 may determine that the function is innocuous if the function involves printing a message.

Automated functions are usually executed in sequence. A similar type of evaluation may be performed at the skill flow as a whole. In some examples, a digital worker may invoke atomic skills/functions. Multiple functions/skills may be combined in a sequence (e.g., a skill flow). This sequence may be called to be executed in the same way as individual functions are called and executed. In some implementations, when assessing the risk on a skill flow, the risk may be assessed for each individual/atomic function, but also the risk of combining the functions (together in a flow) may be assessed. Implementations described herein may be designed to engage a human to approve and review exceptions. In this regard, a layer of human oversight may be added to the decision-making process, potentially increasing security. To handle false positives, risk monitor component 110 can be tuned to balance between automated decisions and human intervention, ensuring that only high-risk actions or uncertain cases are escalated for human review.

As indicated above, FIG. 2 is provided as an example. Other examples may differ from what is described with regard to FIG. 2 of devices shown in FIG. 2 is provided as an example. There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices in FIG. 2.

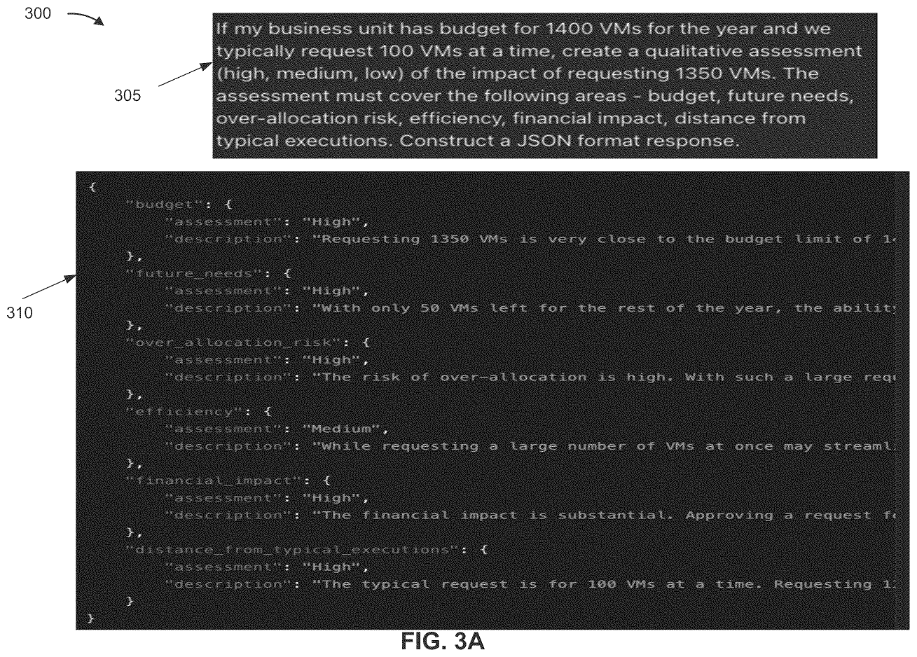

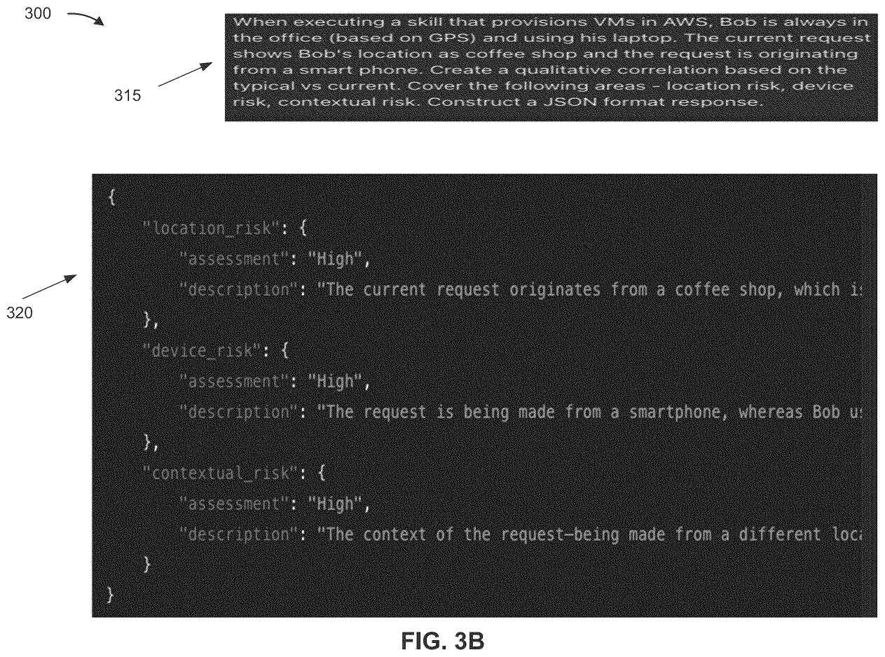

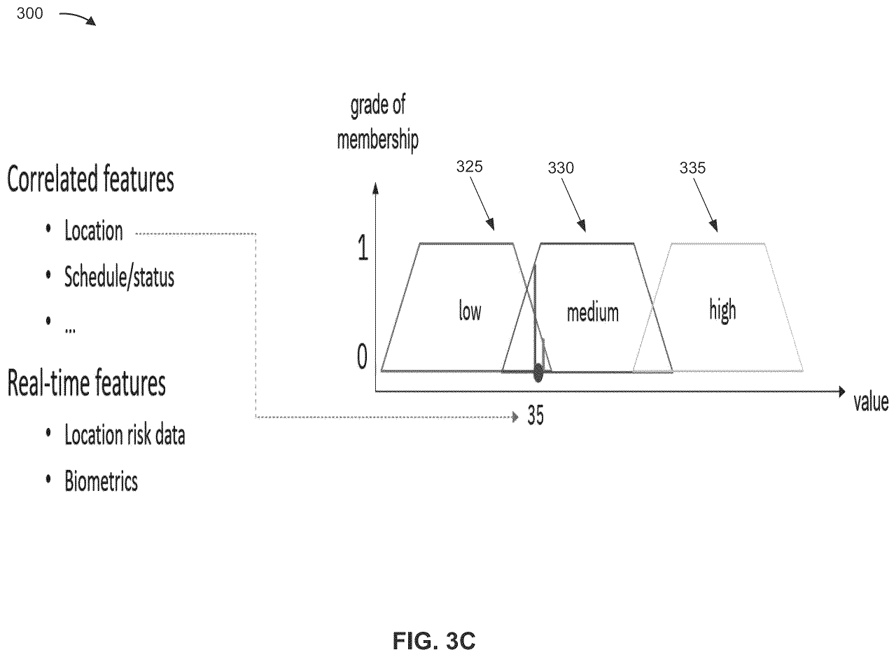

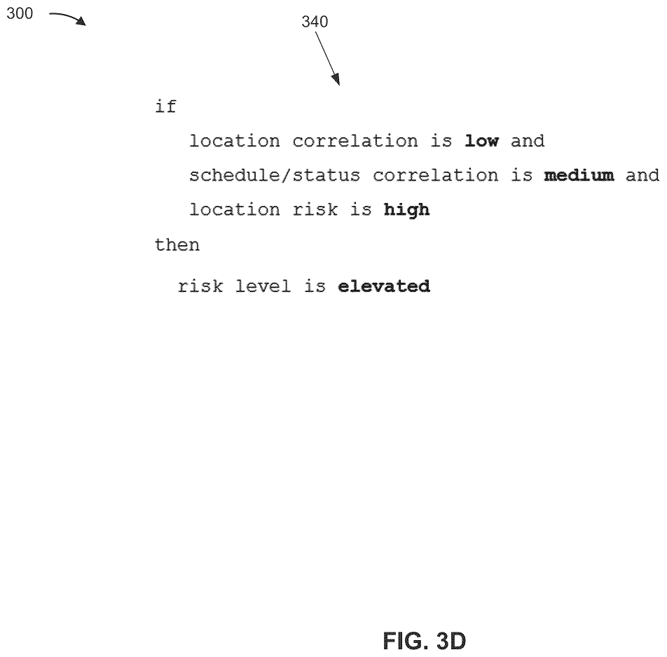

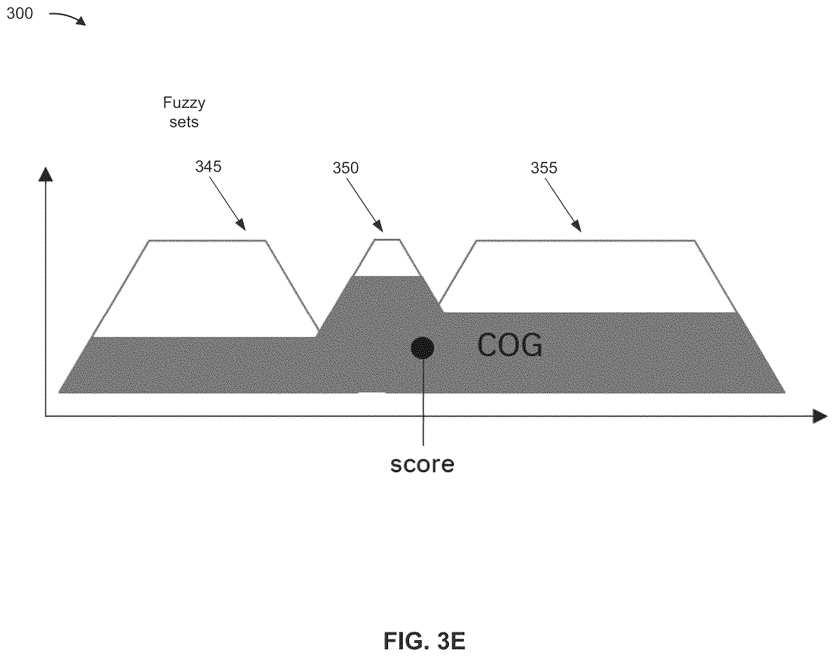

FIGS. 3A-3E are diagrams of an example implementation 300 described herein. Implementation 300 describes a process that may be implemented by risk monitor component 110. As shown in FIG. 3A, risk monitor component 110 may generate a first prompt 305 based on a request to execute a function. As explained herein, the request may be initiated by scheduler component 120, user device 125, or event automation component 130. For example, the request may be provided to execute a function that provisions VMs. For instance, the request may be provided to provision 1350 VMs.

Risk monitor component 110 may analyze the request to identify the function to be executed and to identify a digital worker that executes the function identified by the request. Risk monitor component 110 may analyze the request to identify the parameter for the function (e.g., 1350 VMs.). Risk monitor component 110 may search parameter values data store 255 to identify different areas that are typically affected by the provisioning of VMs. For example, risk monitor component 110 may search parameter values data store 255 to determine budget, future needs, over-allocation risk, efficiency, financial impact, and distance from typical location of execution are areas that may be affected by the provisioning of VMs. Risk monitor component 110 may search parameter values data store 255 to identify historical parameters (e.g., 100 VMs) used when the function is executed. Risk monitor component 110 may search parameter values data store 255 to identify a parameter value (e.g., a number of VMs) allocated to be provisioned for a selected period of time. For example, risk monitor component 110 may determine that 1400 VMs have been allocated to be provisioned over a year.

Based on the information obtained from the request and/or from parameter values data store 255, risk monitor component 110 may generate first prompt 305 to determine a possible impact of executing the function (to provision 1350 VMs). As shown in FIG. 3A, first prompt 305 may identify the historical parameter values typically used for the function, the parameter value allocated for the selected period of time, the areas that may be affected by the provisioning of VMs, among other examples. Additionally, first prompt 305 may request a qualitative assessment of the potential impact of executing the function. In some situations, risk monitor component 110 may include, in first prompt 305, information identifying a selected format for the qualitative assessment. As shown in FIG. 3A, the selected format may include JavaScript Object Notation (JSON).

First prompt 305 may be generated and provided to LLM 110-1 to estimate if the execution of the function creates high risk scenarios (requiring further checks). First prompt 305 may include information regarding historical executions of the function to determine a distance from the norm.

As shown in FIG. 3A, LLM 110-1 may generate a first qualitative assessment 310. As shown in FIG. 3A, first qualitative assessment 310 may provide a qualitative assessment (e.g., high, medium, low) for the different areas identified in first prompt 305. LLM 110-1 may provide a qualitative output because a quantitative score may be generated during defuzzification, as explained herein. In some implementations, LLM 110-1 may be aligned to fit the needs of an entity (e.g., an organization, an individual, among others examples), thereby potentially enabling risk monitor component 110 to reduce the information of information included in a prompt.

As shown in FIG. 3B, risk monitor component 110 may generate a second prompt 315 based on the request to execute the function. In some implementations, risk monitor component 110 may search context data store 260 to determine historical context associated with executing the function. For example, risk monitor component 110 may search context data store 260 (e.g., using information identifying the function) to identify historical contexts, such as a historical location associated with execution of the function, a historical device (e.g., user device) used to initiate execution of the function, a historical date and/or time associated with execution of the function, a historical context associated with execution of the function, historical biometrics associated with execution of the function, a historical status associated with execution of the function, among other examples.

In some implementations, risk monitor component 110 may analyze metadata (associated with the request) to determine current contexts, such as a current location associated with the request, a current device (e.g., user device) used to initiate execution of the function, current date and/or time associated with the request, a historical context associated with execution of the function, current biometrics associated with execution of the function, a current status associated with execution of the function, among other examples. As shown in FIG. 3B, risk monitor component 110 may generate second prompt based on the information obtained from context data store 260 and/or from the metadata.

As shown in FIG. 3B, second prompt 315 may identify the historical location, the historical device, a user of the historical device, a current location, a current device, and a user of the current device. Additionally, second prompt 315 may request a qualitative assessment of the potential impact of executing the function. In some situations, risk monitor component 110 may include, in second prompt 315, information identifying a selected format for the qualitative assessment. As shown in FIG. 3B, the selected format may include JSON.

Second prompt 315 may be generated and provided to LLM 110-1 to qualitatively determine, across multiple dimensions, whether the correlation between the historical (or typical) context and the current (or actual) context are high (e.g., satisfy a correlation threshold).

Generally, with respect to prompt, risk monitor component 110 may ensure that any sensitive information, such as biometrics or personally identifiable information (PII), is either anonymized or abstracted before being processed by LLM 110-1. Contexts and non-sensitive parameters may be used to generate risk assessments. In some implementations, risk monitor component 110 may protect sensitive information by providing, to LLM 110-1, clarifying questions in the form of a zero knowledge proof. LLM 110-1 may provide clarifying answers which are generic (my age is over 21 instead of my date of birth, my heart rate is 30% above my normal resting hear rate, etc.). In some situations, LLM 110-1 may be used is a private to the organization (sovereign AI) and the prompt is not used for encoding/training (decoder-only). By using contextual data (e.g., the nature of the skill, historical usage patterns, and high-level descriptions of actions), risk monitor component 110 may assess the risk and impact without needing to expose user-specific details. For example, instead of using specific user data, risk monitor component 110 may evaluate how the current execution aligns with typical usage patterns and known security postures. Risk monitor component 110 may evaluate a generalization of outcomes and weigh the likelihood of an outcome without knowing the exact detail.

As shown in FIG. 3B, LLM 110-1 may generate a second qualitative assessment 320. As shown in FIG. 3B, second qualitative assessment 320 may provide a qualitative assessment (e.g., high, medium, low) for a risk associated with the correlation. For example, second qualitative assessment 320 may indicate a location risk, a device risk, a contextual risk, a date and time risk, among other examples.

As shown in FIG. 3C, risk monitor component 110 may apply a fuzzy logic-based scoring algorithm, to the potential impact and the correlation, to compute a risk score. This step enable risk monitor component 110 to transform a well-defined value (e.g. the distance in meters between the employee location and their office building) into a qualitative value (e.g., close-by/average/far-away). While examples herein describe 3 fuzzy sets, the nature and number of fuzzy sets used may vary. For example, the nature and number of fuzzy sets may be entirely dependent of the type of quantity measured. For example, for a distance, 4 fuzzy sets may be used. The fuzzy sets may include “same place”, “nearby”, “distant”, and “very remote.”

As shown in FIG. 3C, the fuzzy logic-based algorithm may include fuzzy sets, such as a first fuzzy set 325, a second fuzzy set 330, and a third fuzzy set 335. Risk monitor component 110 may use fuzzy logic rules to determine a grade membership of the potential impact and the correlation to the fuzzy sets. As shown in FIG. 3C, for example, a value of 35 for the “location” context may have approximately a 0.2 grade of membership for first fuzzy set 325 (e.g., “low”) and approximately a 0.8 grade of membership for second fuzzy set 330 (e.g., “medium”). So,

when the fuzzy logic rules involve the “location” context/criterion, the rules will be executed both for a “low” level and a “medium” level.

There may be multiple rules that take in different features/values and use a combination of conjunctions/disjunctions in the conditions to derive a qualitative value of an output feature. As an example of such rules may be used to compute a qualitative value of a risk level. For example, as shown in FIG. 3D, fuzzy logic rules 340 may be used to a risk level based on a location correlation qualitative assessment, a schedule/status qualitative assessment, and a location risk qualitative assessment. In some implementations, other rules may be used are also computing the risk value using different conditions.

Each fuzzy logic rule that is applied may generate a trapezoid (e.g., fuzzy sets). As shown in FIG. 3E, different fuzzy sets may be used, such as fourth fuzzy set 345, fifth fuzzy set 350, and sixth fuzzy set 355. This trapezoid is defined by the fuzzy set of the output value (e.g. the risk), that is clipped to the combination (using min or max) of the membership levels of the features used in the conditions of the rule. For example, if the rule uses “location is low” in our example, the clip level will be at 0.2. As shown in FIG. 3E, three fuzzy logic rules have been applied, each one generating a trapezoid which is a clipping of the fuzzy set definitions for the risk level. The final value of the risk level is computed by calculating the center of gravity of the union of these three trapezoids. In some implementations, other defuzzification techniques may be used (in addition to or alternatively to the center of gravity), such as adaptive integration, basic defuzzification distributions.

As indicated above, FIGS. 3A-3E are provided as an example.

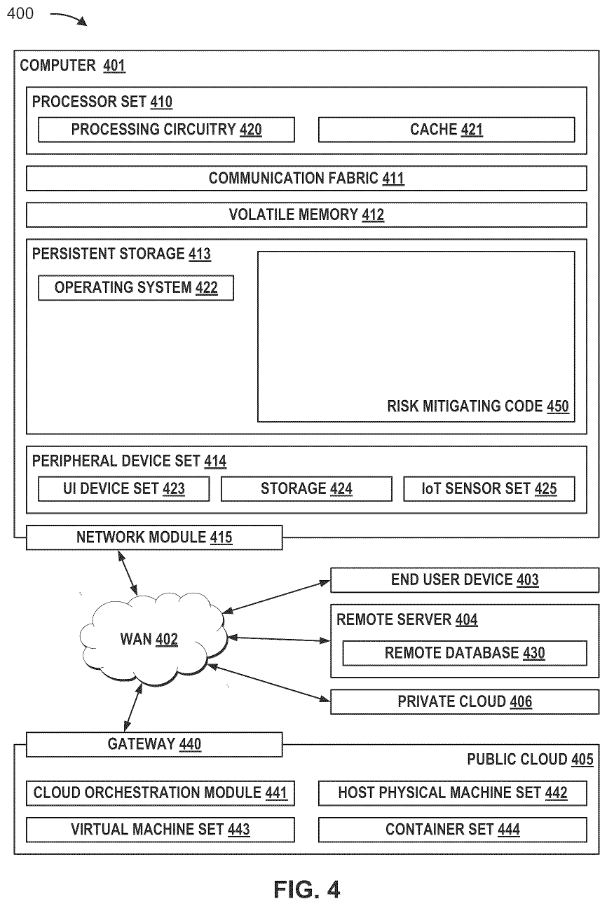

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as risk mitigating code 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

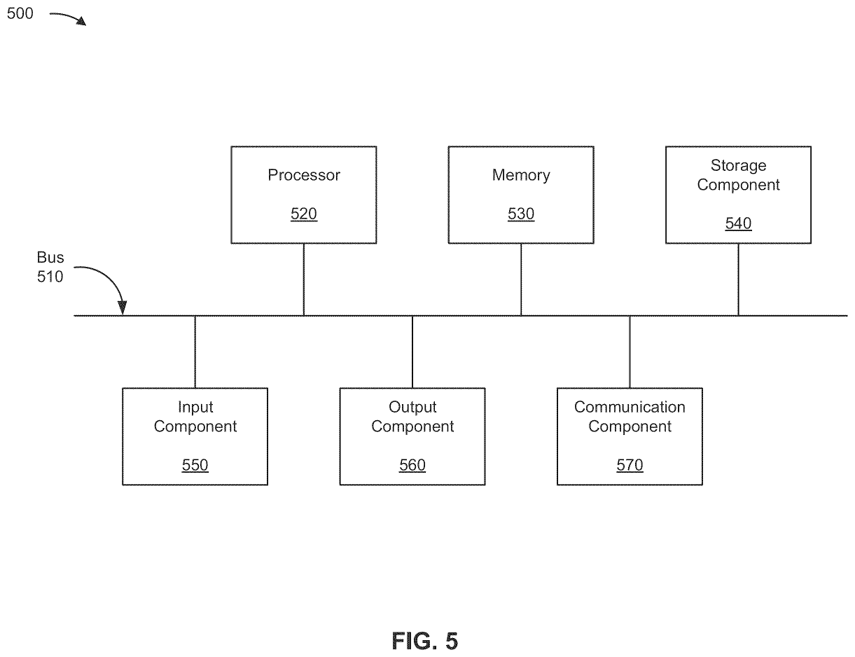

FIG. 5 is a diagram of example components of a device 500, which may correspond to a device that includes digital worker 105 and/or user device 125. In some implementations, a device that includes digital worker 105 and/or user device 125 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

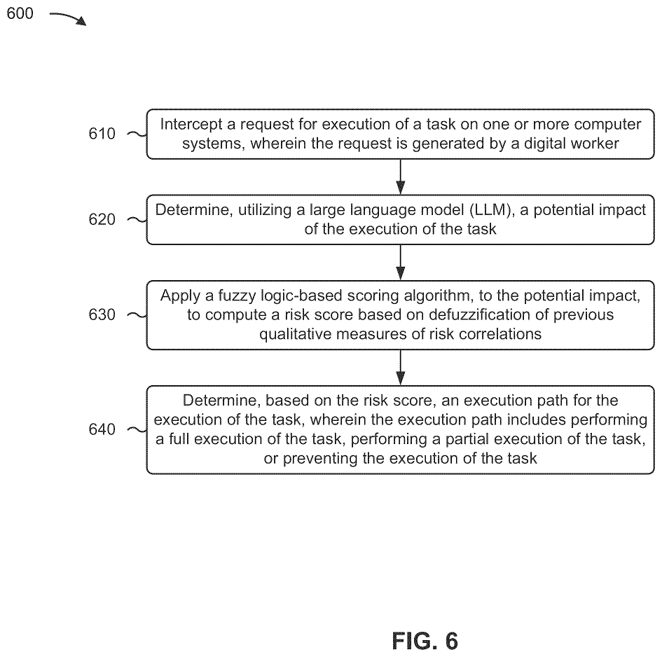

FIG. 6 is a flowchart of an example process 600 associated with mitigating risk of a digital worker executing a function using large language models. In some implementations, one or more process blocks of FIG. 6 may be performed by a risk monitor component (e.g., risk monitor component 110). In some implementations, one or more process blocks of FIG. 6 may be performed by another device or a group of devices separate from or including the risk monitor component, such as scheduler component 120, user device 125, and/or event automation component 130. Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include intercepting a request for execution of a function on one or more computer systems, wherein the request is generated by a digital worker (block 610). For example, the risk monitor component may intercept a request for execution of a function on one or more computer systems, wherein the request is generated by a digital worker, as described above. In some implementations, the request is generated by a digital worker.

As further shown in FIG. 6, process 600 may include determining, utilizing a large language model (LLM), a potential impact of the execution of the function (block 620). For example, the risk monitor component may determine, utilizing a large language model (LLM), a potential impact of the execution of the function, as described above.

As further shown in FIG. 6, process 600 may include applying a fuzzy logic-based scoring algorithm, to the potential impact, to compute a risk score based on defuzzification of previous qualitative measures of risk correlations (block 630). For example, the risk monitor component may apply a fuzzy logic-based scoring algorithm, to the potential impact, to compute a risk score based on defuzzification of previous qualitative measures of risk correlations, as described above.

As further shown in FIG. 6, process 600 may include determining, based on the risk score, an execution path for the execution of the function, wherein the execution path includes performing a full execution of the function, performing a partial execution of the function, or preventing the execution of the function (block 640). For example, the risk monitor component may determine, based on the risk score, an execution path for the execution of the function, wherein the execution path includes performing a full execution of the function, performing a partial execution of the function, or preventing the execution of the function, as described above. In some implementations, the execution path includes performing a full execution of the function, performing a partial execution of the function, or preventing the execution of the function.

In some implementations, the request is provided by a digital worker, and wherein determining the potential impact comprises generating a prompt based on a description of the function and parameter values identified, in the request, for the function, and providing the prompt to the LLM to determine the potential impact of the execution of the function.

In some implementations, process 600 includes determining, using the LLM, a correlation between a current context associated with the function and a historical context associated with the function, wherein the current context is determined based on the request, and applying the fuzzy logic-based scoring algorithm, to the correlation and the potential impact, to compute the risk score.

In some implementations, determining the correlation comprises determining the correlation using current context data associated with the current context and historical context data associated with the historical context, wherein the current context data identifies a location associated with the function, a schedule associated with the function, and a device associated with the function, and wherein the historical context data identifies a historical location associated with the function, a historical schedule associated with the function, and a historical device associated with the function.

In some implementations, process 600 includes determining whether the execution of the function is innocuous, and determining the potential impact of the execution of the function when the execution of the function is not innocuous.

In some implementations, process 600 includes preventing the execution of the function when the risk score is a first score, performing the partial execution of the function when the risk score is a second score, wherein the first score exceeds the second score, and performing a full execution of the function when the risk score is a third score, wherein the second score exceeds the third score.

In some implementations, determining the potential impact comprising ascertaining a plurality of parameters and skill context, and generating qualitative assessments.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
intercepting a request for execution of a function on one or more computer systems,
wherein the request is generated by a digital worker; and
determining, utilizing a large language model (LLM), a potential impact of the execution of the function;
applying a fuzzy logic-based scoring algorithm, to the potential impact, to compute a risk score based on defuzzification of previous qualitative measures of risk correlations; and
determining, based on the risk score, an execution path for the execution of the function,
wherein the execution path includes performing a full execution of the function, performing a partial execution of the function, or preventing the execution of the function.

2. The method of claim 1, wherein the request is provided by a digital worker, and
wherein determining the potential impact comprises:
generating a prompt based on a description of the function and parameter values identified, in the request, for the function; and
providing the prompt to the LLM to determine the potential impact of the execution of the function.

3. The method of claim 1, further comprising:
determining, using the LLM, a correlation between a current context associated with the function and a historical context associated with the function,
wherein the current context is determined based on the request; and
applying the fuzzy logic-based scoring algorithm, to the correlation and the potential impact, to compute the risk score.

4. The method of claim 3, wherein determining the correlation comprises:
determining the correlation using current context data associated with the current context and historical context data associated with the historical context,
wherein the current context data identifies a location associated with the function, a schedule associated with the function, and a device associated with the function, and
wherein the historical context data identifies a historical location associated with the function, a historical schedule associated with the function, and a historical device associated with the function.

5. The method of claim 1, further comprising:
determining whether the execution of the function is innocuous; and
determining the potential impact of the execution of the function when the execution of the function is not innocuous.

6. The method of claim 5, further comprising:
preventing the execution of the function when the risk score is a first score;
performing the partial execution of the function when the risk score is a second score,
wherein the first score exceeds the second score; and
performing a full execution of the function when the risk score is a third score,
wherein the second score exceeds the third score.

7. The method of claim 1, wherein determining the potential impact comprising:
ascertaining a plurality of parameters and skill context; and
generating qualitative assessments.

8. A computer system comprising:
a processor set;
one or more computer-readable storage media; and
program instructions stored on the one or more computer-readable storage media to cause the processor set to perform operations comprising:
intercepting a request for execution of a function on one or more computer systems;
determining, utilizing a large language model (LLM), a potential impact of the execution;
determining, utilizing the LLM, a correlation between a current context associated with the function and a historical context associated with the function;
applying a fuzzy logic-based scoring algorithm, to the potential impact and the correlation, to compute a risk score associated with the execution of the function; and
based on the risk score, selectively:
performing a full execution of the function,
performing a partial execution of the function, or
preventing the execution of the function.

9. The system of claim 8, wherein determining the correlation comprises:
determining the correlation using current context data associated with the current context and historical context data associated with the historical context,
wherein the current context data identifies a location associated with the function, a schedule associated with the function, and a device associated with the function, and
wherein the historical context data identifies a historical location associated with the function, a historical schedule associated with the function, and a historical device associated with the function.

10. The system of claim 9, wherein the current context data includes biometric data associated with the function, and
wherein the historical context data includes biometric data associated with the function.

11. The system of claim 10, wherein the function is included in functions that are executed in a sequence,
wherein determining the potential impact of the execution comprises determining the potential impact of the execution in accordance with the sequence, and
wherein determining the correlation comprises determining the correlation in accordance with the sequence.

12. The system of claim 8, wherein preventing the execution of the function comprises preventing the execution of the function when the risk score is a first score, and
wherein performing the partial execution of the function comprises performing the partial execution of the function when the risk score is a second score, and
wherein the first score exceeds the second score.

13. The system of claim 11, wherein performing the full execution of the function comprises performing the full execution of the function when the risk score is a third score,
wherein the second score exceeds the third score.

14. The system of claim 8, wherein determining the potential impact of the execution comprises determining the potential impact of the execution the function and parameter values identified, in the request, for the function.

15. A computer program product comprising:
one or more computer-readable storage media; and
program instructions stored on the one or more computer readable storage media to perform comprising:
determining, utilizing a machine learning model, a potential impact of execution a function on one or more computer systems;
determining, utilizing the machine learning model, a correlation between a current context associated with the function and a historical context associated with the function;
applying a fuzzy logic-based scoring algorithm, to the potential impact and the correlation, to compute a risk score associated with the execution of the function; and
based on the risk score, selectively:
performing a full execution of the function,
performing a partial execution of the function, or
preventing the execution of the function.

16. The computer program product of claim 15, wherein determining the potential impact of the execution comprises:
determining the potential impact of the execution the function and parameter values identified for the function.

17. The computer program product of claim 15, wherein determining the correlation comprises:
determining the correlation using current context data associated with the current context and historical context data associated with the historical context,
wherein the current context data identifies a location associated with the function, a schedule associated with the function, and a device associated with the function, and
wherein the historical context data identifies a historical location associated with the function, a historical schedule associated with the function, and a historical device associated with the function.

18. The computer program product of claim 17, wherein the current context data includes biometric data associated with the function, and
wherein the historical context data includes biometric data associated with the function.

19. The computer program product of claim 15, wherein preventing the execution of the function comprise preventing the execution of the function when the risk score is a first score,
wherein performing the partial execution of the function comprises performing the partial execution of the function when the risk score is a second score, and
wherein the first score exceeds the second score.

20. The computer program product of claim 19, wherein performing the full execution of the function comprises performing the full execution of the function when the risk score is a third score,
wherein the second score exceeds the third score.
